(19) United States
(12) Patent Application Publication
(10) Pub. No.: US 2011/0053695 A1
(43) Pub. Date: Mar. 3, 2011

(54) SHUDDERLESS INBOARD CONSTANT VELOCITY JOINT

(76) Inventor: Dongyung Yun, Jinchen-Kun (KR)

(21) Appl. No.: 12/848,551

(22) Filed: Aug. 2, 2010

(30) Foreign Application Priority Data
Aug. 25, 2009 (KR) 10-2009-0078884

(51) Int. Cl. F16D 3/30

(52) U.S. Cl. 464/11

(57) ABSTRACT

A shudderless inboard CV joint having both oil storage chambers formed around each track of an outer race and around a journal of a trunnion and an oil groove formed in an outer ring of each roller assembly. The CV joint includes an outer race connected to a first shaft and having tracks therein; a trunnion connected to a second shaft and having radial journals; and a roller assembly having both an inner ring fitted over each journal and an outer ring engaging with each track so as to be movable in an axial direction of the track, wherein an oil storage chamber is formed around an upper portion of each track and oil is supplied to the oil storage chamber, thus reducing friction formed between the track and the outer ring.

### BACKGROUND OF THE INVENTION

1. Field of the Invention

The present invention relates to low-friction inboard constant velocity joints and, more particularly, to a low-friction inboard constant velocity joint, which can reduce the friction and joint axial force generated during operation, thus realizing improved anti-NVH (Noise, Vibration and Harshness) performance.

2. Description of the Related Art

Generally, as shown in FIG. 1, a tripod CV (Constant Velocity) joint comprises an outer race 10 integrally connected to a stub shaft 11, a trunnion 18 inserted into an inner track of the outer race 10 and spline-coupled to a half shaft, thus transmitting power to the half shaft, and a roller assembly 13 fitted over each of three journals 20 of the trunnion 13 and absorbing relative movement generated between an associated track 12 of the outer race 10 and the journal 20 of the trunnion 18.

When the half shaft is inclined relative to the stub shaft 11 during operation of the tripod CV joint, relative movement is generated between the track 12 of the outer race 10, the trunnion 18 and the roller assemblies 13, thus generating a friction force between them. The friction force generates an axial force in an axial direction of the half shaft. The axial force has three peak values per one revolution of the tripod CV joint.

When a high load acts on the CV joint, for example, due to a quick start of a vehicle or when the joint angle formed between the stub shaft and the half shaft is at a high angle, the axial force is increased and causes the vehicle to shudder in a transverse direction.

### SUMMARY OF THE INVENTION

Accordingly, the present invention has been made keeping in mind the above problems occurring in the related art and the present invention is intended to propose a shudderless inboard CV joint, which has both oil storage chambers formed around an upper portion of each track of an outer race and around a journal of a trunnion and an oil groove formed along a circumference of an outer ring of each roller assembly, wherein oil is supplied both to the oil storage chambers and to the oil grooves, thus reducing the frictional resistance formed between the track and the outer ring and between an inner ring and the trunnion journal.

According to one aspect of the present invention, there is provided a shudderless inboard CV joint, comprising: an outer race connected to a first shaft and having a plurality of tracks therein; a trunnion connected to a second shaft and having a plurality of journals protruding in radial directions; and a roller assembly having both an inner ring fitted over each of the journals of the trunnion and an outer ring engaging with each of the tracks of the outer race so as to move in an axial direction of the track, the inner and outer rings being arranged concentrically, wherein an oil storage chamber is formed around an upper portion of each of the tracks and oil is supplied to the oil storage chamber, thus reducing a friction formed between the track and the outer ring.

The shudderless inboard CV joint, according to the present invention, has the following advantages.

1. Due to the oil storage chamber formed around the upper portion of each track of the outer race, oil can easily flow in the frictional contact junction between the tract and the outer ring, thus realizing maximum lubrication effects.

2. Round surface parts formed in the outer circumferential surface of the outer ring come into two-point contact with the track, thus stably maintaining horizontality of the rollers during the rolling of the rollers.

3. The oil groove formed along the circumference of the outer ring can reduce the frictional resistance formed between the outer ring and the track.

4. Each of the trunnion journals has wide angle portions and narrow angle portions, so that the shudderless inboard CV joint can maintain the stable situation of the roller assembly under a high load.

5. Due to the oil storage chamber formed around each of the trunnion journals, the shudderless inboard CV joint can reduce the frictional resistance formed between the inner ring and the journal.

Therefore, the shudderless inboard CV joint of the present invention can reduce both the frictional resistance and the axial force formed by relative movement between the trunnion journals, the inner rings, the outer rings and the tracks, thus realizing improved anti-NVH (Noise, Vibration and Harshness) performance.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is an exploded perspective view illustrating an assembly of an outer race and a trunnion of a shudderless inboard CV joint according to an embodiment of the present invention;

FIG. 2 is a perspective view of the assembly of FIG. 1 after being assembled;

FIG. 3 is a sectional view illustrating an action of the shudderless inboard CV joint of FIG. 2 when shafts joined to the joint are inclined to each other;

FIG. 4 is a view of the shudderless inboard CV joint of FIG. 2, viewed in a front view and in a partially enlarged view;

FIG. 5 is a perspective view of the trunnion shown in FIG. 1;

FIG. 6 is a front view of FIG. 5;

FIG. 7 is a partially enlarged view of one trunnion journal shown in FIG. 6;

FIG. 8 is a sectional view taken along line Y-Y of FIG. 7;

FIG. 9 is a sectional view taken along line X-X of FIG. 1;

FIG. 10 is a partially sectioned view of a roller assembly shown in FIG. 1; and

FIG. 11 is a partially enlarged view of FIG. 4.

### DETAILED DESCRIPTION OF THE INVENTION

Hereinbelow, a shudderless inboard CV joint according to an embodiment of the invention will be described in detail with reference to the accompanying drawings.

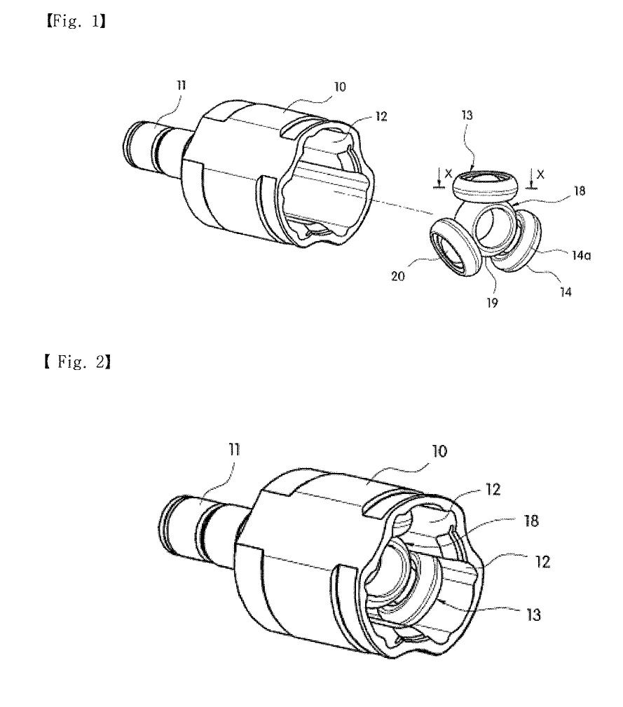

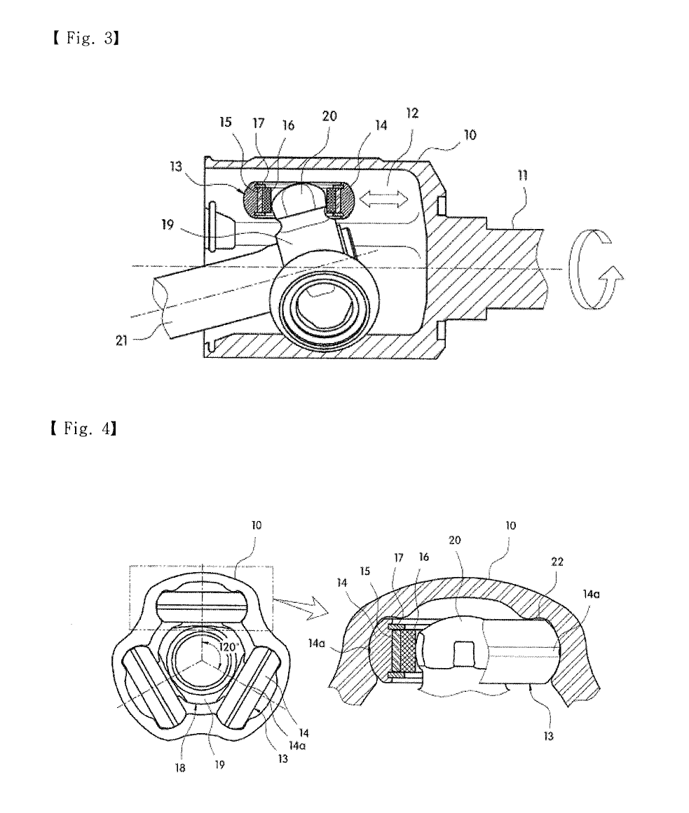

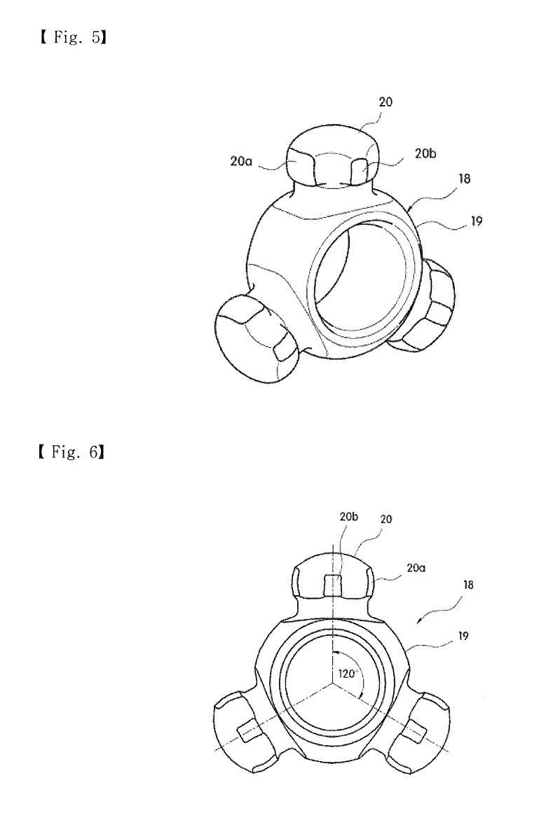

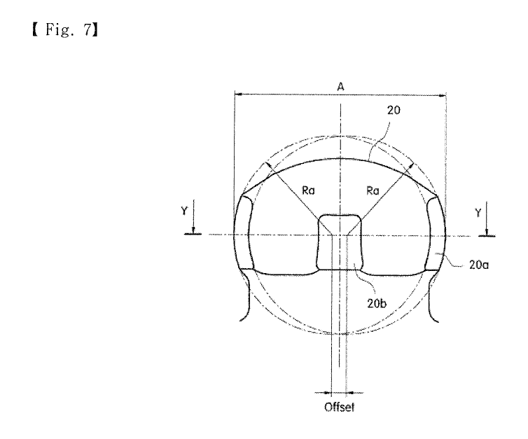

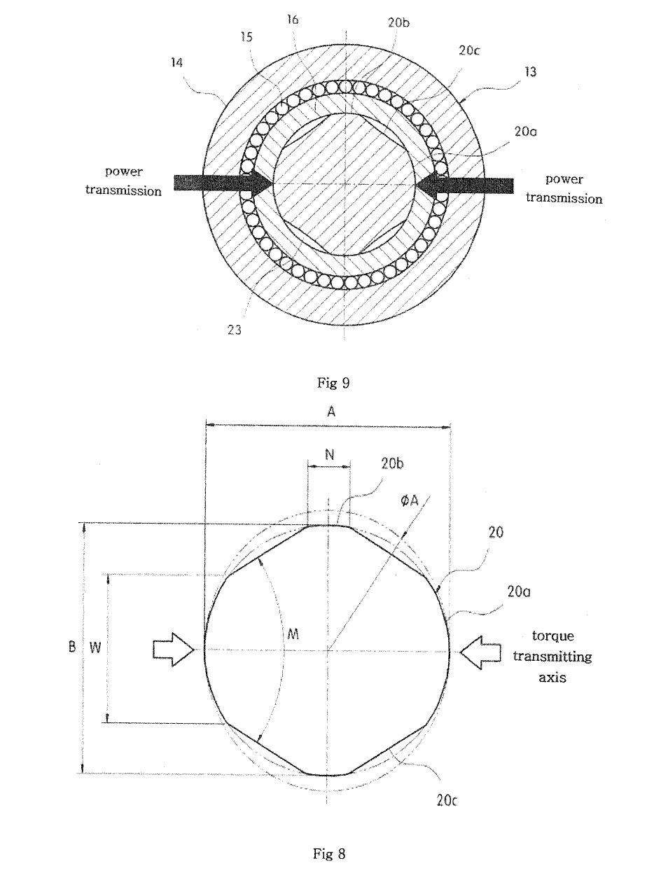

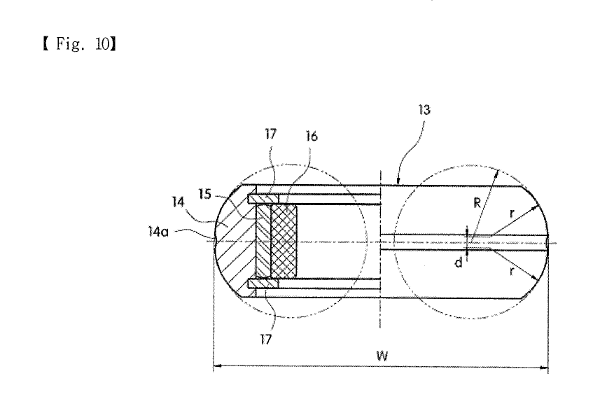

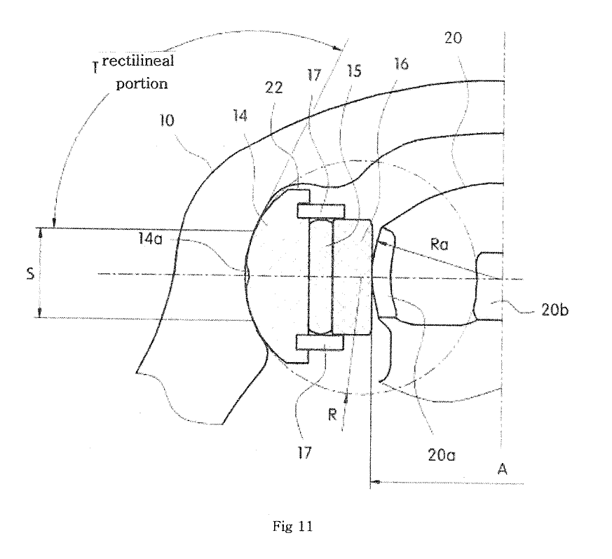

FIG. 1 is an exploded perspective view illustrating an assembly of an outer race and a trunnion of a shudderless inboard CV joint according to an embodiment of the present invention. FIG. 2 is a perspective view of the assembly of FIG. 1 after being assembled. FIG. 3 is a sectional view illustrating an action of the shudderless inboard CV joint of FIG. 2 when shafts joined to the joint are inclined to each other. FIG. 4 is a view of the shudderless inboard CV joint of FIG. 2, viewed in a front view and in a partially enlarged view. FIG. 5 is a perspective view of the trunnion shown in FIG. 1. FIG. 6 is a front view of FIG. 5. FIG. 7 is a partially enlarged view of one trunnion journal shown in FIG. 6. FIG. 8 is a sectional view taken along line Y-Y of FIG. 7. FIG. 9 is a sectional view taken along line X-X of FIG. 1. FIG. 10 is a partially sectioned view of a roller assembly shown in FIG. 1. FIG. 11 is a partially enlarged view of FIG. 4.

The present invention provides a CV (Constant Velocity) joint which can transmit a rotational force at a constant velocity regardless of a joint angle between shafts. Particularly, the present invention provides a shudderless inboard CV joint which can realize improved anti-NVH (Noise, Vibration and Harshness) performance.

The shudderless inboard CV joint (sometimes so-called “LSJ (Least Shudder Joint)”) is a CV joint which can reduce both the friction and a joint axial force generated by relative movement formed between an outer race 10 and a trunnion assembly, thus minimizing the transverse shudder of a vehicle.

The shudderless inboard CV joint (LSJ) according to an embodiment of the present invention comprises an outer race 10 and a trunnion assembly and transmits a rotational force of a first shaft to a second shaft at a constant velocity regardless of the joint angle formed between the two shafts.

The outer race 10 is integrated with a stub shaft 11 (first shaft) such that the outer race 10 can rotate along with the stub shaft 11 at the same time. Three tracks 12 are axially formed in the outer race 10 at angularly spaced locations such that respective roller assemblies 13 of the trunnion assembly seated in the tracks 12 can rotatably move in axial directions of the tracks 12.

Describing in detail the structure of each track 12, as shown in FIG. 4 and FIG. 11, the three tracks 12 are angularly spaced apart from each other in the outer race 10 at angles of 120°. Each of the tracks 12 comprises a curved portion S formed in each side surface of the track 12 and having both a predetermined radius R of curvature and a predetermined height, and a rectilineal portion T extending from an upper end of the curved portion S in a direction tangent to the curved portion S at a predetermined angle.

Here, the curved portion S is brought into curved-surface contact with an outer ring 14 of a roller assembly 13 which will be described later herein. The rectilineal portion T forms an oil storage chamber 22 around the upper portion of the track 12, thus supplying oil to the upper portion of the track 12 and reducing the friction force generated by relative movement between the track 12 and the outer ring 14.

The trunnion assembly is inserted into the outer race 10 and functions to transmit a rotational force, and comprises a trunnion 18 and a roller assembly 13.

The trunnion 18 is spline-coupled to a half shaft 21, so that, when the half shaft 21 rotates, the trunnion 18 is rotated in the same direction.

The trunnion 18 comprises a retaining ring 19 for receiving the half shaft 21 therein and three journals 20, which protrude outwards from the circumference of the retaining ring 19 in radial directions. The retaining ring 19 has a shaft hole therein to be spline-coupled to the half shaft 21.

Each of the journals 20 of the trunnion 18 comprises round-shaped wide angle portions 20a formed on the left and right ends of the journal 20 at locations placed on torque transmission axes, as shown in FIG. 7, round-shaped narrow angle portions 20b formed on the front and rear ends of the journal 20 at locations perpendicular to the torque transmission axes, as shown in FIG. 8, and recess portions 20c extending between the wide angle portions 20a and the narrow angle portions 20b.

The wide angle portions 20a have respective curved surfaces, which have a width W and a radius Ra of curvature based on respective centers offset by a predetermined distance from a central axis of the journal 20 in opposite directions. The maximum distance A between ends of the wide angle portions 20a is defined along the major axis of an ellipse formed by the two offset centers. The wide angle portions 20a coincide with the curve of the ellipse.

Here, the ratio of Ra to A/2 is expressed by the equation Ra=(0.982˜0.998)A/2.

The narrow angle portions 20b form the ellipse in cooperation with the wide angle portions 20a and has a width N (N<W). The narrow angle portions 20b coincide with the curve of the ellipse. The maximum distance B between ends of the narrow angle portions 20b is defined along the minor axis of the ellipse.

The major axis of the ellipse is aligned with the torque transmission axes, while the minor axis of the ellipse is perpendicular to the torque transmission axes. The length difference A−B between the major axis A and the minor axis B of the ellipse is 0.02˜0.05 mm.

As described above, both the wide angle portions 20a and the narrow angle portions 20b of the journal 20 have respective round shapes, so that, when the journal 20 is in contact with an inner ring 16 of the roller assembly 13 which will be described later herein, the round portions 20a and 20b can stably maintain horizontality of the roller assembly 13 (see FIG. 3).

Further, the recess portions 20c connect the wide angle portions 20a to the narrow angle portions 20b and four recess portions 20c are formed at four locations such that the recess portions 20c are not in contact with the inner ring 16 of the roller assembly 13. Defined between the inner ring 16 and the recess portions 20c are oil storage chambers 23. Lubrication oil is supplied to the oil storage chambers 23, thus reducing the frictional resistance formed between the journal 20 and the inner ring 16 and realizing an increased lubrication performance of the shudderless inboard CV joint.

In the embodiment, each of the recess portions 20c has a rectilineal surface as shown in the drawings. However, it should be understood that the recess portions may be formed as curved surfaces without affecting the functioning of the present invention.

The roller assembly 13 functions to transmit a rotational force from the trunnion 18 to the outer race 10 and comprises an outer ring 14, a needle bearing 15, an inner ring 16 and a retainer 17.

Described in detail, as shown in FIG. 10, the outer ring 14 has a round-shaped appearance and comprises round surface parts 14b having a radius r of curvature based on respective centers offset by a predetermined distance d/2 from the diametrical axis of the outer ring 14 in opposite directions, and a circumferential oil groove 14a formed along the circumference of the outer surface of the outer ring 14, along which the round surface parts 14b meet together.

The roller assembly 13 transmits torque to the outer race 10 in a state in which round surface parts 14b formed in upper and lower portions of the outer circumferential surface of the outer ring 14 are in two-point contact with the track 12 of the outer race 10, so that the CV joint of the present invention can stably maintain the horizontality of the outer ring 14 in a rolling direction and can reduce contact stress between the track 12 and the outer ring 14.

Further, oil can be supplied to the oil groove 14a formed along the circumference of the outer surface of the outer ring 14, thus reducing the frictional resistance formed between the outer ring 14 and the track 12 of the outer race 10 and realizing an increased lubrication performance of the shudderless inboard CV joint.

A needle bearing 15 is installed between the inner ring 16 and the outer ring 14 and is retained in a desired location inside the outer ring 14 by the retainer 17, thus controlling relative movement between the inner ring 16 and the outer ring 14.

The inner ring 16 is in contact with the journal 20 of the trunnion 18. Described in detail, an inner rectilineal surface of the inner ring 16 is in contact with the round outer surface of the trunnion journal 20, so that, even when the trunnion journal 20 is tilted in the track 12 at an angle, the roller assembly 13 can maintain horizontality thereof.

The operational effect of the shudderless inboard CV joint according to the embodiment of the present invention will be described hereinbelow.

When the half shaft 21 rotates, the trunnion 18 spline-coupled to the half shaft 21 rotates in the same direction. Thus, the roller assembly 13 assembled with the trunnion journal 20 rotates in a torque transmitting direction, so that the outer race 10 engaged with the roller assembly 13 rotates. Therefore, a stub shaft 11 integrally connected to the outer race 10 is rotated.

When the joint is angled, that is, when the half shaft 21 is inclined relative to the stub shaft 11 at an angle of inclination, the trunnion journal 20 is tilted from the inner ring 16 of the roller assembly 13 at a tilting angle.

Here, the roller assembly 13 transmits the torque to the outer race 10 in a state in which the round surface parts 14b of the outer ring 14 are in two-point contact with the track 12 of the outer race 10, so that the roller assembly 13 can stably maintain horizontality thereof and can reduce contact stress during the rolling thereof in which the roller assembly 13 rolls and moves in an axial direction of the track 12.

In the shudderless inboard CV joint, oil contained in the oil groove 14a formed along the circumference of the outer ring 14 can reduce the frictional resistance formed between the outer ring 14 and the track 12 of the outer race 10, thus improving lubrication performance of the CV joint.

Further, oil contained in the four oil storage chambers 23 defined by the recess portions 20c of the trunnion journal 20 can reduce the frictional resistance formed between the inner ring 16 and the trunnion journal 20, so that the lubrication performance of the CV joint can be further improved.

Further, oil contained in the oil storage chamber 22 defined by the rectilineal portion T of the track 12 can reduce the frictional resistance formed between the track 12 of the outer race 10 and the outer ring 14, thus further improving lubrication performance of the CV joint.

Described again, the oil supplied both to the oil storage chamber 22 defined by the track 12 and to the oil groove 14a of the outer ring 14 can reduce the frictional resistance formed between the track 12 and the outer ring 14, and the oil supplied to the oil storage chambers 23 defined by the trunnion journal 20 can reduce the frictional resistance formed between the inner ring 16 and the trunnion journal 20. Thus, the shudderless inboard CV joint of the present invention can reduce the axial force of the half shaft 21 and the stub shaft 11, thereby realizing improved anti-NVH performance.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A shudderless inboard constant velocity joint, comprising:
an outer race connected to a first shaft and having a plurality of tracks therein;
a trunnion connected to a second shaft and having a plurality of journals protruding in radial directions; and
a roller assembly comprising both an inner ring fitted over each of the journals of the trunnion and an outer ring engaging with each of the tracks of the outer race such that the outer ring can move in an axial direction of the track, the inner and outer rings being arranged concentrically,
wherein an oil storage chamber is formed around an upper portion of each of the tracks and oil is supplied to the oil storage chamber, thus reducing friction formed between the track and the outer ring.

2. The shudderless inboard constant velocity joint as set forth in claim 1, wherein to form the oil storage chamber, the track comprises a curved portion formed in each side surface of the track and having a predetermined radius of curvature, and a rectilineal portion extending from an upper end of the curved portion in a direction tangent to the curved portion at a predetermined angle.

3. The shudderless inboard constant velocity joint as set forth in claim 1, wherein the outer ring comprises a plurality of round surface parts formed in upper and lower portions of an outer circumferential surface of the outer ring such that each round surface part has a predetermined radius of curvature, wherein the round surface parts are in two-point contact with the track, thus maintaining the situation of the roller assembly during a rolling motion of the roller assembly and reducing contact stress.

4. The shudderless inboard constant velocity joint as set forth in claim 3, wherein the round surface parts have respective centers of the radius of curvature, the centers being offset by a predetermined distance from a diametrical axis of the outer ring in opposite directions.

5. The shudderless inboard constant velocity joint as set forth in claim 3, wherein the outer ring comprises an oil groove formed along a circumference of the outer circumferential surface of the outer ring, along which the round surface parts meet together, wherein oil is supplied to the oil groove, thus reducing friction between the track and the outer ring.

6. The shudderless inboard constant velocity joint as set forth in claim 1, wherein each of the journals comprises: wide angle portions formed on ends of the journal at locations placed on torque transmission axes such that the wide angle portions coincide with a curve of an ellipse; narrow angle portions formed on ends of the journal at locations perpendicular to the torque transmission axes such that the narrow angle portions coincide with the curve of the ellipse; and recess portions extending between the wide angle portions and the narrow angle portions, with oil storage chambers formed between the recess portions and the inner ring.

7. The shudderless inboard constant velocity joint as set forth in claim 6, wherein the wide angle portions of the journal have respective curved surfaces having a radius of curvature based on respective centers offset by a predetermined distance from a central axis of the journal in opposite directions.

8. The shudderless inboard constant velocity joint as set forth in claim 1, wherein the recess portion is formed as a rectilineal surface or a curved surface.
